(19) United States
(12) Patent Application Publication
(10) Pub. No.: US 2025/0388298 A1
(43) Pub. Date: Dec. 25, 2025

(54) INFLATABLE LADDER

(71) Applicant: Trent Zimmer, Youngsville, LA (US)

(72) Inventor: Trent Zimmer, Youngsville, LA (US)

(21) Appl. No.: 19/245,827

(22) Filed: Jun. 23, 2025

Related U.S. Application Data
(60) Provisional application No. 63/663,225, filed on Jun. 24, 2024.

(51) Int. Cl. B63B 27/14

(52) U.S. Cl. CPC B63B 27/146

(57) ABSTRACT

An inflatable ladder is disclosed. The inflatable ladder includes an elongated vertical support element defining at least one interior air chamber configured to be inflated by a pressurized gas, and a plurality of vertically spaced rungs that are formed in the vertical support element. Each rung includes an opening that extends through or is recessed into the vertical support element. In some implementations, vertically adjacent rungs are oriented perpendicular to each other and configured to function as both handholds and footholds. An inlet valve is coupled to the air chamber and is configured to selectively admit and expel gas. When inflated, the ladder provides structural rigidity sufficient to support a user. The inflatable design of the ladder facilitates compact storage and easy transportation when not in use.

### CROSS-REFERENCE TO RELATED APPLICATION(S)

This application claims the benefit of U.S. Provisional Application Ser. No. 63/663,225, filed on Jun. 24, 2024, the entirety of which is incorporated herein by reference.

### TECHNICAL FIELD

This disclosure relates to implementations of an inflatable ladder.

### BACKGROUND

Inflatable ladders are often employed in environments where traditional ladders are impractical due to constraints on storage space, transportation ease, and rapid deployment. Traditional ladders often require substantial storage volume and may pose difficulties during transportation and installation, particularly in emergency, marine, or military applications where time and mobility are often critical. Thus, there is a need for lightweight, compact, and rapidly deployable ladder solutions that provide reliable structural stability and ease of use in a variety of operational environments.

Accordingly, there exists a need for inflatable ladders disclosed herein. The present invention is directed to providing an inflatable ladder configured to address these and other needs.

### SUMMARY OF THE INVENTION

It is to be understood that this summary is not an extensive overview of the disclosure. This summary is exemplary and not restrictive, and it is intended neither to identify key or critical elements of the disclosure nor delineate the scope thereof. The sole purpose of this summary is to explain and exemplify certain concepts of the disclosure as an introduction to the following complete and extensive detailed description.

An inflatable ladder is disclosed. The inflatable design of the ladder facilitates easy transportation and compact storage when not in use.

In one example implementation, an inflatable ladder comprises an elongated vertical support element defining at least one interior air chamber configured to be inflated by a pressurized gas; a plurality of vertically spaced rungs formed in the vertical support element, each rung comprising an opening extending through or recessed into the vertical support element; and an inlet valve coupled to the at least one interior air chamber, the inlet valve being configured to selectively admit and expel gas from the air chamber. The inflatable ladder, when inflated, provides structural rigidity sufficient to support a user.

In another example implementation, an inflatable ladder comprises an elongated vertical support element defining at least one interior air chamber configured to be inflated by a pressurized gas; a plurality of vertically spaced rungs formed in the vertical support element, each rung comprising an opening extending through or recessed into the vertical support element; an attachment feature disposed on the elongated vertical support element, the attachment feature comprising a cutout and a lip configured to hook over a support structure; and an inlet valve coupled to the at least one interior air chamber, the inlet valve being configured to selectively admit and expel gas from the air chamber. The inflatable ladder, when inflated, provides structural rigidity sufficient to support a user.

### BRIEF DESCRIPTION OF THE DRAWINGS

FIGS. 1 and 2 illustrate an inflatable ladder according to the principles of the present disclosure.

FIG. 3 illustrates a cutaway view of the inflatable ladder shown in FIG. 2, taken along section lines 3-3.

FIG. 4 illustrates another inflatable ladder according to the principles of the present disclosure.

FIG. 5 illustrates the inflatable ladder shown in FIG. 4 attached to the railing of a ship.

Like reference numerals refer to corresponding parts throughout the several views of the drawings.

### DETAILED DESCRIPTION

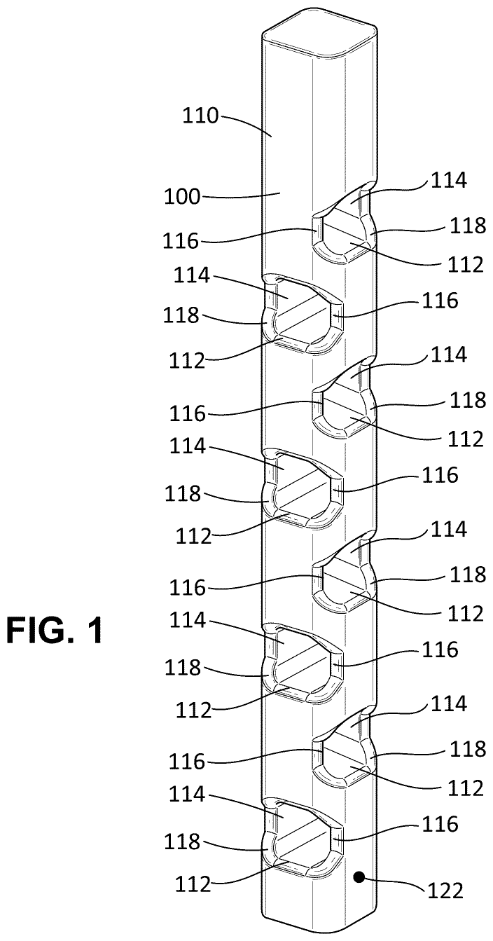

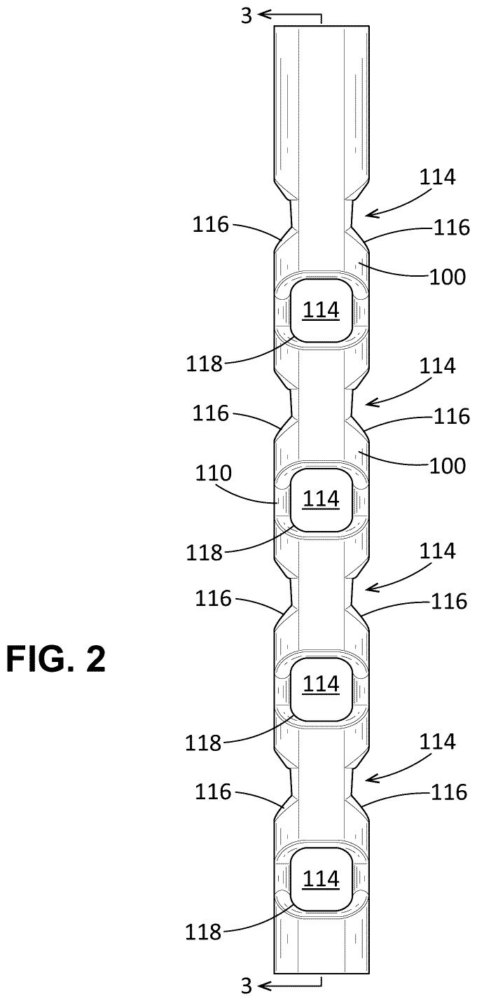

FIGS. 1 and 2 illustrate an inflatable ladder 100 according to the principles of the present disclosure. The inflatable design of the ladder 100 facilitates easy transportation and compact storage when not in use.

As shown in FIGS. 1 and 2, the inflatable ladder 100 comprises an elongated vertical support element 110 with a plurality of rungs 112 defined by openings 114 extending through the vertical support element 110. However, in other implementations, the opening 114 defining each rung 112 may not extend through the vertical support element 110 and instead may form a recess that is closed at one end (not shown). The rungs 112 are evenly spaced along the length of the vertical support element; however, the spacing may vary in alternative implementations. Each rung 112 is oriented perpendicular to the rungs 112 immediately above and below it, forming an alternating pattern of handholds and footholds. When a user stands on a particular rung 112, the rungs 112 positioned above and perpendicular to it can be used as handholds. In particular, the external mouth 116 at each end of the opening 114 defining a rung 112 includes at least one edge 118 configured to serve as a handhold.

Each rung 112 includes an approximately 8-inch-wide opening 114 that extends through the vertical support element 110. However, in other implementations, one or more of the openings 114 may be wider or narrower than 8 inches, as long as they are at least wide enough to receive the foot of a user. Each opening 114 comprises a bottom side, a top side, and two vertical sidewalls extending between the top and bottom sides. The external mouth 116 at each end of the opening 114 defining a rung 112 includes at least one edge 118 suitable for use as a handhold when the inflatable ladder 100 is being climbed. This edge 118 is shaped and optionally textured to facilitate use as a handhold.

The inflatable ladder 100 may also include one or more attachment features to secure the ladder during use. An exemplary attachment feature may be a hook feature for attachment to the railing of a ship or similar support structure.

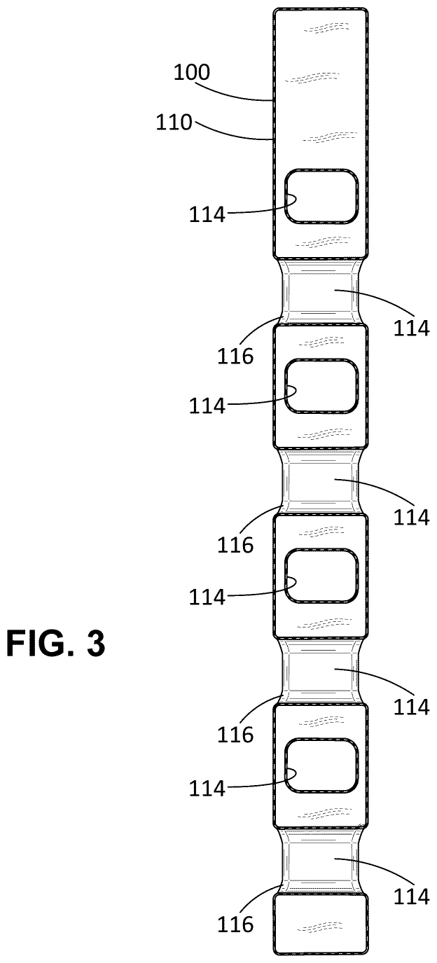

As shown in FIG. 3, the inflatable ladder 100 defines a single, contiguous interior air chamber 120. However, in other implementations, the inflatable ladder 100 may define two or more interconnected interior air chambers. The inflatable ladder 100 includes an inlet valve 122 configured to prevent backflow of pressurized gas. The inlet valve 122 may be a Boston-type valve, but one of ordinary skill in the art, having the benefit of the present disclosure, would be able to select an appropriate inlet valve 122. The air chamber 120 can be inflated from a single gas source. Inflation and deployment of the inflatable ladder 100 may be facilitated by a gas source, such as an air compressor, a nitrogen cartridge, or another pressurized gas cartridge. The interior air chamber 120 is preferably inflated to a pressure of approximately 10 to 15 PSI. However, in alternate implementations, the pressure may be lower or higher than 10 to 15 PSI, provided that the selected pressure is sufficient to maintain the structural rigidity of the inflatable ladder 100 during use.

To stow the inflatable ladder 100, it is deflated by opening a deflation orifice of the inlet valve 122 and compressing the vertical support element 110 to expel the trapped gas from the air chamber 120. If a vacuum source is available, it may be connected to the inlet valve 122 using standard connectors to rapidly purge the trapped gas. In some implementations, the deflated ladder 100 is stored within a protective tube.

The inflatable ladder 100 may be made of a heavy-duty vinyl or polyvinyl chloride (PVC) material, having weights ranging from approximately 10 oz per square yard to approximately 22 oz per square yard. However, in some implementations, lighter vinyl or polyvinyl chloride (PVC) materials weighing less than 10 oz per square yard may be used to reduce weight, while a heavier vinyl or PVC material exceeding 22 oz per square yard may be chosen for increased durability.

While the example inflatable ladder 100 has a rectangular-shaped cross-section comprising four sides, other implementations of the inflatable ladder 100 may have a triangular cross-section with three sides.

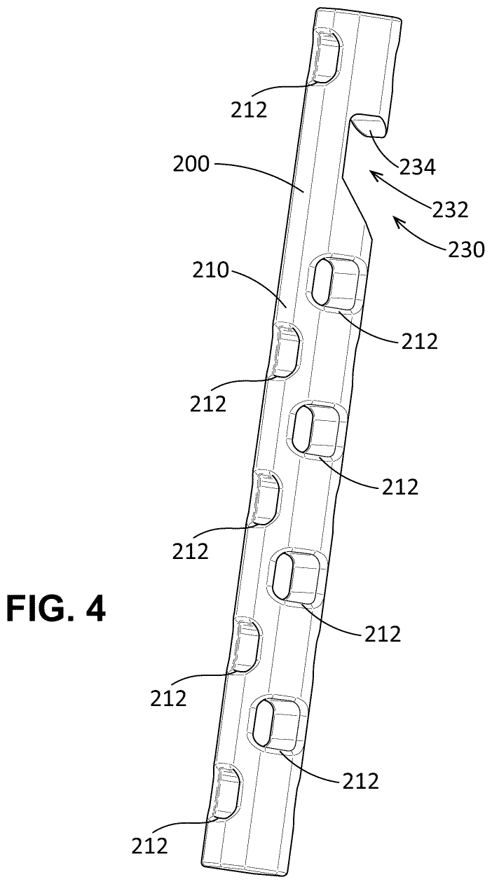

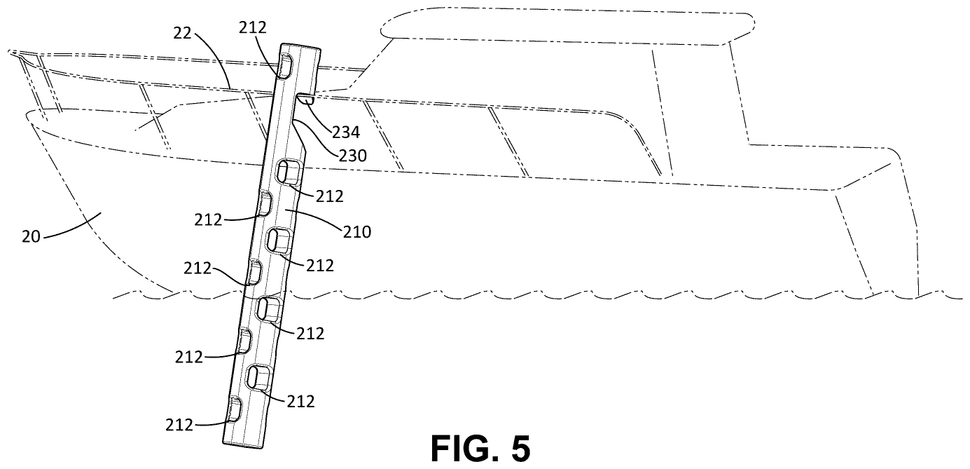

FIGS. 4 and 5 illustrate another inflatable ladder 200 according to the principles of the present disclosure. The inflatable ladder 200 is similar to the inflatable ladder 100 discussed above, but the vertical support element 210 includes an attachment feature 230.

The attachment feature 230 is configured to engage with the railing 22 of a ship 20, or a similar support structure. The attachment feature 230 comprises a cutout 232, configured to receive the railing 22, and a lip 234 that hooks over the railing 22, thereby securing the inflatable ladder 200 in position (see, e.g., FIG. 5). The vertical support element 210 may include at least one rung 212 positioned above the attachment feature 230, which is intended to serve as a handhold, providing the user with a surface to grip when boarding the ship 20.

The foregoing description of the invention is intended to be illustrative; it is not intended to be exhaustive or to limit the claims to the precise forms disclosed. Those skilled in the relevant art can appreciate that many modifications and variations are possible in light of the foregoing description and associated drawings.

Reference throughout this specification to an “embodiment” or “implementation” or words of similar import means that a particular described feature, structure, or characteristic is included in at least one embodiment of the present invention. Thus, the phrase “in some implementations” or a phrase of similar import in various places throughout this specification does not necessarily refer to the same embodiment.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

1. An inflatable ladder comprising:
an elongated vertical support element defining at least one interior air chamber configured to be inflated by a pressurized gas;
a plurality of vertically spaced rungs formed in the vertical support element, each rung comprising an opening extending through or recessed into the vertical support element; and
an inlet valve coupled to the at least one interior air chamber, the inlet valve being configured to selectively admit and expel gas from the air chamber;
wherein the inflatable ladder, when inflated, provides structural rigidity sufficient to support a user.

2. The inflatable ladder of claim 1, wherein vertically adjacent rungs are oriented perpendicular to each other and are each configured to function as both handholds and footholds.

3. The inflatable ladder of claim 2, wherein each opening defining one of the rungs includes at least one external edge shaped to facilitate use as a handhold.

4. The inflatable ladder of claim 1, wherein at least two vertically adjacent rungs are oriented perpendicular to each other and are each configured to function as both handholds and footholds.

5. The inflatable ladder of claim 4, wherein each opening defining one of the rungs includes at least one external edge shaped to facilitate use as a handhold.

6. An inflatable ladder comprising:
an elongated vertical support element defining at least one interior air chamber configured to be inflated by a pressurized gas;
a plurality of vertically spaced rungs formed in the vertical support element, each rung comprising an opening extending through or recessed into the vertical support element;
an attachment feature disposed on the elongated vertical support element, the attachment feature comprising a cutout and a lip configured to hook over a support structure; and
an inlet valve coupled to the at least one interior air chamber, the inlet valve being configured to selectively admit and expel gas from the air chamber;
wherein the inflatable ladder, when inflated, provides structural rigidity sufficient to support a user.

7. The inflatable ladder of claim 6, wherein vertically adjacent rungs are oriented perpendicular to each other and are each configured to function as both handholds and footholds.

8. The inflatable ladder of claim 7, wherein each opening defining one of the rungs includes at least one external edge shaped to facilitate use as a handhold.

9. The inflatable ladder of claim 6, wherein at least two vertically adjacent rungs are oriented perpendicular to each other and are each configured to function as both handholds and footholds.

10. The inflatable ladder of claim 9, wherein each opening defining one of the rungs includes at least one external edge shaped to facilitate use as a handhold.

11. The inflatable ladder of claim 6, wherein at least one of the plurality of vertically spaced rungs formed in the vertical support element is located above and below the attachment feature.
